(19) United States
(12) Patent Application Publication
(10) Pub. No.: US 2013/0071810 A1
(43) Pub. Date: Mar. 21, 2013

(54) AUXILIARY DEVICE FOR MARKING THE LOCATION OF THE INSTALLATION OF DENTAL IMPLANTS

(71) Applicant: Carlos Alberto Bergamasco de Freitas, Sao Paulo (BR)

(72) Inventor: Carlos Alberto Bergamasco de Freitas, Sao Paulo (BR)

(21) Appl. No.: 13/699,709

(22) PCT Filed: Apr. 7, 2011
(86) PCT No.: PCT/BR11/00101

§ 371 Date: Nov. 23, 2012

(30) Foreign Application Priority Data
May 25, 2010 (BR) MU 9.000.773-5

(51) Int. Cl. A61C 8/00

(52) U.S. Cl. CPC A61C 8/009
USPC 433/72

(57) ABSTRACT

The present Utility Model Patent relates to Auxiliary Device Marking the Location of Installation of Dental Implant made of various materials such as titanium, surgical steel, metal alloys, polyethylene, acrylic polymers, other suitable plastic and other characterized as being composed by rod (2), basis (3), spacer (4); universal marker (5a), a marker for total edentulous (5b) and safety lock (6) and these components interact and help in planning surgical and prosthetic when selecting which implant to be installed in accordance with and edentulous space and whose selection is defined by marking devices (5a) used to simulate the extent of the platforms or diameters of the implants, including variable measures as required, and these universal labels (5a) provided with an oblong opening in the center so it is possible to pass a drill, lance type, spherical, helical and any other exercising this function and make a marking and initial drilling in the bone where the implant is being installed. The markers (5b) for edentulous totals include two sets with four markers each, one set to install up to five implants and other implants to install six implants with diameter and platforms of variables measures maintaining a distance of 3 to 6 mm between each implant and may extend to other dimensions and finally the spacers (4) are used to calculate and maintain the distance between adjacent tooth and implant and, thus, as between implants comprising variable measures as needed.

### BRIEF DESCRIPTION

This descriptive report of Utility Model Patent is related to Auxiliary Device for Marking the Location of Dental Implant characterized by being constituted by the device to be used as a auxiliary tool to distribution of implants and define the set up on the bone so that they remain at a appropriate distance from the adjacent tooth and between implants, to be established by a dentist, both mesiodistal and anteroposterior and buccal lingual.

It is worth highlighting that the Auxiliary Device For Marking the Location of Installation of Dental Implant requested in this report the granting of privilege, it is basically constituted by a rod, base, spacer, marker, and security lock, which interact between them, helping surgical and prosthetic planning when selecting where to install the implant, and this selection is defined by marking devices used to simulate the extent of the platforms or diameter and length of linear bone implants, comprising several steps.

In addition, it is worth the connotation that these markers are provided with an oblong opening in the center and a semicircular opening in markers for total edentulous so you can spend a drill lance, spherical or helical type and thus allow a knife to mark and initial drilling of the bone.

### SCOPE

The scopes of this Auxiliary Device For Marking The Location Of Dental Implants refer to its use in dentistry, especially in implantodonty.

### PURPOSE

The purpose of this Auxiliary Device To Marking the Location of Dental Implant, as its name suggests, aims to help the Dental Surgery to do the marking of where the bone will be drilled to install the implant, providing the versatility and freedom in selecting of any implant diameter on the market, such as providing freedom of choice for any distance between the tooth-implant and implant-tooth-implant as well as set the number of implants to be installed, something that the devices on the market do not.

### STATUS OF THE TECHNIQUE

In the status of the technique and as is well known among professionals in the area known that several means used to define the spaces between natural teeth and dental implants as well as between them, pointing out that in most cases, the positive results obtained from such surgeries are merely results of the quality and experience available to the professional.

### DIFFERENTIAL TECHNIQUE

The Auxiliary Device To Marking Location of Dental Implant was created aiming at improving the concepts used to dental implants, which deploys a spacing system whose technical differential lies in:

Use of auxiliary device for dental implants with universal guide that allows the selection of any Universal Marker matching the diameter of the implant or any sequence in its platform, switching and allowing the mix of brands, models and diameter of implants according to the wishes of the dentist in any region of the mouth;

Use of the auxiliary device for dental implants provided with resources to use spacers in order to calculate and maintain the distance between implant and adjacent tooth as well as between implants;

Use of auxiliary device for dental implants where the spacers have several possibilities of size to distance of the adjacent tooth implant or another contiguous implant;

Use of auxiliary device for dental implants in edentulous total defined as markers for total edentulous either upper or lower, which aims to improve the selection of the quantity and diameter of implants to be placed and the distance between them according to the area or perimeter bone were found to make a total prefixed thesis or removable prosthesis type on denture.

### DESCRIPTION OF THE DRAWINGS

To obtain a total and complete view of how consists the Auxiliary Device Marking the Location of Dental Implant, now in question and the subject of this Utility Model Patent, follow the attached drawings to which reference is made, as follows:

FIG. 1: Matches perspective view partially exploded Auxiliary Device for Marking the Location of the Installation of Dental Implants.

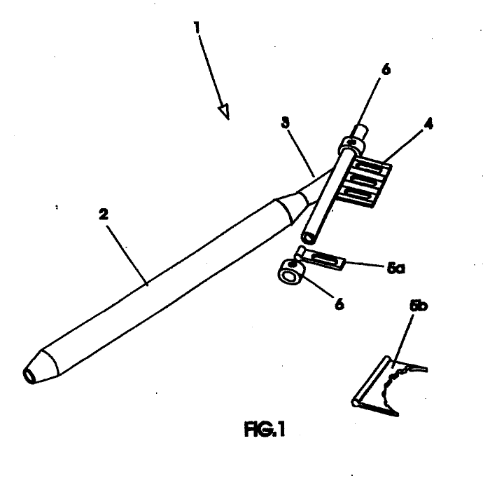

FIG. 2 A/B: Respectively illustrate the marker for total edentulous and even being used by the auxiliary device for making the location of the installation of dental implants.

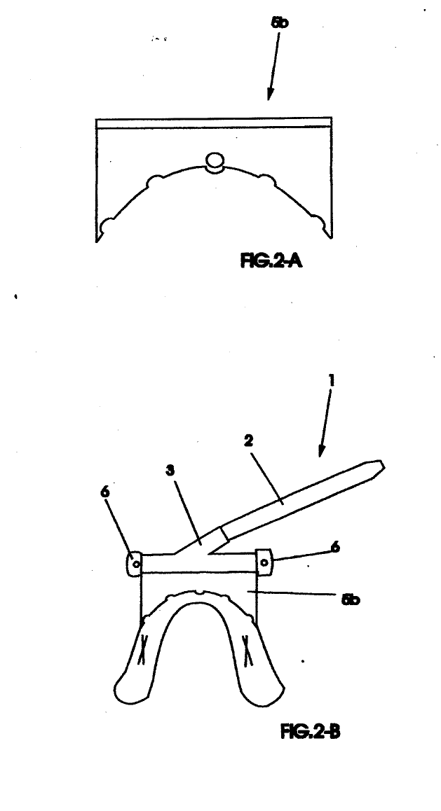

FIG. 3A/B: Reinstatements of two views of the auxiliary device being used interchangeably (marker and spacer) marker at a free end.

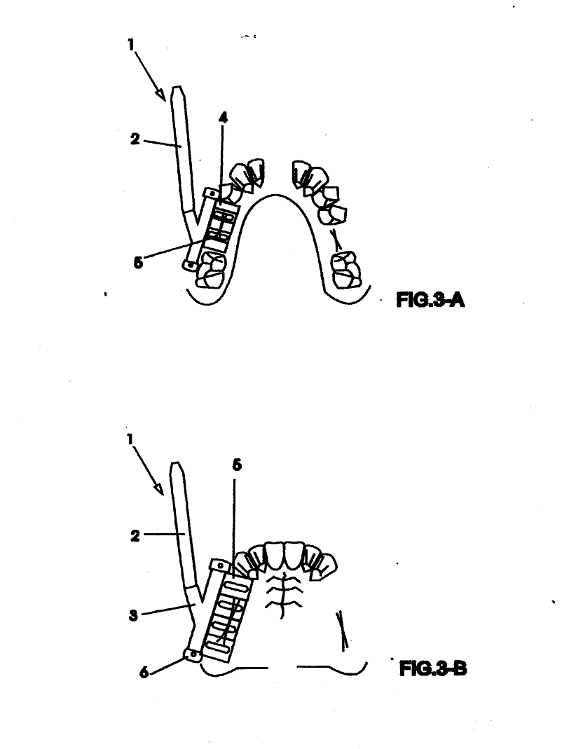

### DESCRIPTION OF THE UTILITY MODEL

As shown by the drawings accompanying and made part of this report, the Auxiliary Device to Marking the Location of the Installation of Dental Implant (1) is manufactured in various materials such as titanium, surgical steel, metal alloys, polyethylene, acrylic polymers or others appropriate to this purpose and characterized as consisting of rod (2), basis (3), spacer (4); universal marker (5a), a marker for total edentulous (5b) and safety lock (6).

It is worthy to mention that all the components that make up this device (1) interact between them, assisting in surgical and prosthetic planning when selecting which the implant to be installed in accordance with the space edentulous (toothless). This selection defined by marking devices (5a) used to simulate the extent of the platforms or diameters of the implants, including variable measures as needed.

In addition, it is worth the connotation that these universal markers (5a) are provided of a oblong opening in the center so it is possible to pass a drill, lance type, spherical, helical or otherwise exercising this function and so if the knife marking and drilling the bone. This oblong opening has the aim to allow the bone thickness viewing for the Dental Surgery to have the freedom to choose the best location to make the initial marking.

The advantage of this device is that you can select any universal marker (5a) corresponding to the platform diameter or the implant diameter and in any sequence, alternating and mixing the brands and models of the implants in accordance with the wishes of the dentist before even surgery could begin, for this, using the plaster model of the patient as a reference.

The Spacers (4) are used to calculate and maintain the distance between the implant and adjacent tooth and between implants comprising variable measures as needed.

Both components, markers (5a and 5b) and spacers (4), have a thickness of 1 mm or any other suitable thickness did not change its function.

It is worth to highlighting that the base (3) serves to accommodate the spacers (4) and markers (5a and 5b), offering the possibility of putting them in any order (5th), so that can be used in any region of the mouth, such as the right posterior superior and inferior, left posterior superior and inferior, anterior superior and inferior.

The rod (2) coupled to base (3) in variable angle and it serves to the dentist to hold device and brings it to the patient's mouth.

The security locks (6) serve to stabilize the spacers (4) and markers (5a and 5b) in order that should prevent them from slipping and falling during the procedure to use.

It is also worth highlighting that for the application of markers for total edentulous (5b) are used specific markers for each dental arch length, not requiring the use of spacers (4).

Specifically, but may extend to other dimensions, the markers (5b) for edentulous totals include two set with four markers each, one set to install up to five implants and another to install up to six implants with platform measures variables.

The set with four Markers for total edentulous for five implants differ from each other by a distance that will implant the other being that this distance can vary between 3 and 6 mm and may extend to other dimensional and follows the same way with Markers edentulous total to six implants.

### CONCLUSION

From what has been described and illustrated it is concluded that it is an Auxiliary Device for Marking the Location of Installation of Dental Implants (1), which fits perfectly within the rules governing the Utility Model Patent and should fill an important gap in the market, even more to offer the benefits herein described in the relevant section and deserves the foregoing and as a consequence, the respective privilege.

1. “AUXILIARY DEVICE FOR MARKING THE LOCATION INSTALLATION OF DENTAL IMPLANTS” (1), made of various materials such as, titanium, surgical steel, metal alloys, polyethylene, acrylic, or other suitable polymers, characterized per consist of rod (2), base (3), spacer (4);
universal marker (5a); marker for total edentulous (5b) and safety lock (6) and these components interact between them, assistant in surgical and prosthetic planning when selecting which the implant to be installed in accordance with and edentulous space and whose selection is by devices markers (5a) used to simulate the extent of the platforms or diameters of the implants, including variable measures as needed.

2. “AUXILIARY DEVICE FOR MARKING THE LOCATION OF INSTALLATION OF DENTAL IMPLANTS”, (1), characterized as claim number one, because these universal markers (5a) are provided with an oblong opening in the center so it is possible to pass a drill, lance type, spherical, helical and any other exercising this function.

3. “AUXILIARY DEVICE FOR MARKING THE LOCATION OF INSTALLATION OF DENTAL IMPLANTS” (1), characterized as claim number one, because the spacers (4) are used to calculate and maintain the distance between adjacent tooth and implant and, thus as between implants comprising variable measures as needed.

4. “AUXILIARY DEVICE FOR MARKING THE LOCATION OF INSTALLATION OF DENTAL IMPLANTS” (1), characterized as claim number one, because the markers (5b) for edentulous totals include two sets with four markers each, one to install up to five implants and another to install up to six implants with diameters of platforms and variables measures maintaining a distance from 3 to 6 mm between each implant may extend to other dimensions.
